(19) United States
(12) Patent Application Publication
(10) Pub. No.: US 2021/0227906 A1
(43) Pub. Date: Jul. 29, 2021

(54) MOISTURE WICKING ALUMINIZED SAFETY GEAR

(71) Applicant: Tex Tech Industries, Inc., North Monmouth, ME (US)

(72) Inventors: David A. BRAHMS, South Portland, ME (US); Vincent GALLACHER, Falmouth, ME (US)

(73) Assignee: Tex Tech Industries, Inc., North Monmouth, ME (US)

(21) Appl. No.: 17/229,282

(22) Filed: Apr. 13, 2021

Related U.S. Application Data
(63) Continuation of application No. PCT/US2020/051919, filed on Sep. 22, 2020.
(60) Provisional application No. 62/904,206, filed on Sep. 23, 2019.

(51) Int. Cl. A41D 31/12; A41D 13/08; A41D 13/05; A41D 31/02; A41D 31/08

(52) U.S. Cl. CPC A41D 31/125; A41D 13/08; A41D 31/085; A41D 31/02; A41D 13/0543

(57) ABSTRACT

A safety garment material is designed to be used in high temperature environments where aluminized personal protection equipment is required gear to protect workers from high radiant heat as well as accidental molten metal splashing or spills. The material includes a plurality of layers of nonwoven fire-resistant oxidized polyacrylonitrile (OPAN) arranged in a wicking configuration to wick moisture away from the wearer's body and layer of perforated aluminized film to allow escape of moisture from the wearer's body.

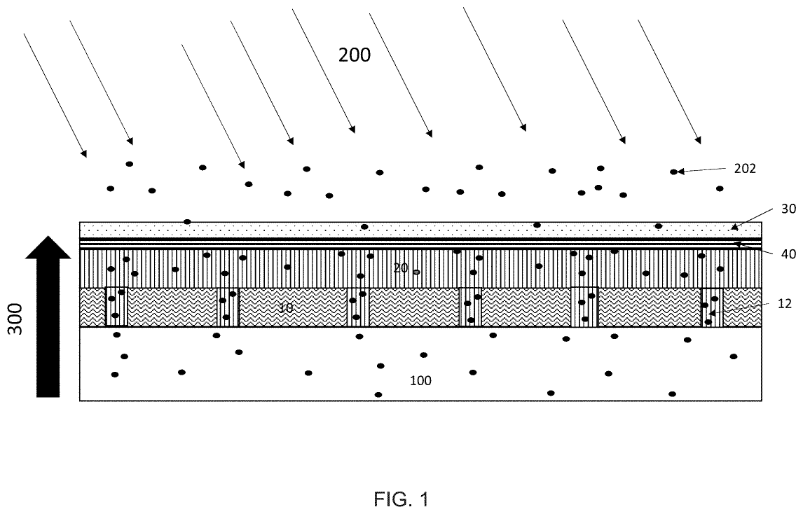

This application is a continuation of PCT Application No. PCT/US2020/051919 filed Sep. 22, 2020 and claims the benefit of U.S. Provisional Application No. 62/904,206, filed Sep. 23, 2019, which are all incorporated by reference in their entireties.

### BACKGROUND OF THE INVENTION

Personal protection equipment (PPE) currently in the marketplace is comprised of a woven, knit, or nonwoven material comprised of fire-resistant fibers such as p-aramid, m-aramid, glass, fire-resistant (FR) Rayon, or oxidized polyacrylonitrile (OPAN). This material is used as an insulation layer in contact with the user, and also as a substrate or carrier for a solid aluminized polyethylene terephthalate (PET) film that provides the main source of radiant heat protection and a non-stick surface so that molten metal slides off instead of adhering to the garment and burning through to the worker and causing injury. While these products provide the required molten metal protection to meet the ASTM International (ASTM) standard F955-15, they are generally considered uncomfortable, because the solid aluminized PET layer does not breathe and allow perspiration and body heat to escape.

An example of a fire protective garment material incorporating an outer aluminized film is disclosed in U.S. Pat. No. 5,948,708, which is incorporated by reference.

### SUMMARY OF THE INVENTION

A safety garment material according to the invention is designed to be used in high temperature environments where aluminized personal protection equipment is required gear to protect workers from high radiant heat as well as accidental molten metal splashing or spills. A garment material according to the invention includes a plurality of nonwoven oxidized polyacrylonitrile (OPAN) layers arranged in a wicking configuration to wick moisture away from the wearer's body and a layer of aluminized film which has been perforated to allow escape of moisture from the wearer's body.

In one aspect, the invention is embodied as a safety garment material comprising an outer side and an inner, body-facing side, with a first nonwoven fabric hydrophobic layer on the inner, body-facing side consisting essentially of hydrophobic oxidized polyacrylonitrile fibers and having areal density of 2-8 ounces per square yard and a second nonwoven fabric hydrophilic layer outward of the first nonwoven fabric layer, consisting essentially of hydrophilic oxidized polyacrylonitrile fibers, mechanically attached to the first nonwoven fabric layer, and having areal density of 2 to 8 ounces per square yard. The first and second nonwoven layers may be supported by a lightweight scrim, outwardly of the two nonwoven layers. The material also includes a perforated radiant heat resistant outer layer comprising aluminum and having 50-2000 perforations per square inch.

In another aspect, the invention is embodied as a method for making a safety garment material, comprising the steps of: laying up 2 to 8 ounces per square yard (opsy) of hydrophilic staple oxidized polyacrylonitrile (OPAN) fibers and 2-8 opsy of hydrophobic staple oxidized OPAN fibers in a needlepunching apparatus with a supporting outer scrim; performing a needlepunching operation to consolidate the layers, forming a consolidated fabric having a body-facing side of predominantly hydrophobic fibers, a layer outward of the hydrophobic layer consisting essentially of hydrophilic fibers, and the outer scrim, wherein tufts of the hydrophilic fibers penetrate the predominantly hydrophobic layer, forming moisture-conducting channels through the hydrophobic body-facing layer; adhering an aluminized film to the outer scrim; and performing a needlepunching operation to form perforations in the aluminized film.

The fabric is characterized by an increased moisture (or water vapor) transmission rate (MVT) and is effective moving heat and moisture away from a wearer's body while maintaining essential protection from fire and splatter. The material is flexible and lightweight so that it can be cut, stitched and bonded using conventional textile processing techniques to fabricate PPE, such as coats having sleeves, pants having leg holes and other outerwear, that may be worn without discomfort.

### BRIEF DESCRIPTION OF THE FIGURE

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawing which schematically depicts a multilayer safety garment material comprising a hydrophobic body-facing layer, a hydrophilic layer outward of the body-facing layer, a scrim and a perforated aluminized layer. Features not necessary for an understanding of the invention are not shown.

### DETAILED DESCRIPTION OF THE INVENTION

Rather than relying on a homogenous fiber blend and construction for the insulating layer, the safety garment material according to the invention comprises an engineered system of nonwoven fiber layers attached to a light and open scrim. Specifically, a hydrophobic fire-resistant fiber is used to form a first layer, ultimately on the wearer- or body-facing side, and a layer formed from hydrophilic fiber is then needled onto the first layer. Thus, the body facing layer in the finished material is predominantly hydrophobic and the outer layer is predominantly hydrophilic. However, tufts of hydrophilic fibers are pushed through the hydrophobic layer in the needling process to form channels which aid in the transmission of moisture away from the wearer in a finished garment. Thus, a layer is “predominantly” hydrophobic fibers when 50-2000 penetrations per square inch (PPSI) of hydrophilic staple fibers have been incorporated in the course of consolidating the material. A hydrophobic barrier having hydrophilic fibers at a lower concentration is in contact with the skin to allow moisture generated through perspiration to be drawn away from the body. Perforations in the aluminized film allow transmission of moisture vapor away from the wearer and away from the garment. This action of moving water away from the skin using the properties of the fibers used creates a cooling effect for the end user.

The preferred fire-resistant fiber used in the nonwoven layers is oxidized polyacrylonitrile (OPAN) in the 1.5 denier to 5 denier range, which fibers have a suitable blend of fire-resistance, weight and processability with the needlepunching apparatus for performance in the finished fabric.

As a benchmark to determine whether a fiber is hydrophobic, American Association of Textile Chemists and Colorists (AATCC) Test Method 79 may be used. Preferably, a water droplet is not absorbed into a hydrophobic material according to the invention within 10 minutes in this test. A water droplet is absorbed into a material according to the invention within 10 minutes is characterized as sufficiently hydrophilic to be used in the dual layer wicking structure. In embodiments, the hydrophilic material absorbs a droplet of water in the AATCC Test Method 79 in less than one minute and even within a few seconds. The adjacent hydrophobic layer resists droplet absorption according to the same test for at least 10 minutes. In embodiments, both layers are OPAN and the hydrophobic layer is coated with a polysiloxane to ensure water resistance.

Another applicable test is Japan Industrial Standard (JIS) L1907 Section 7.1.5, “Vertical Wicking Test”, which is a 30 minute test measuring the wicking of water up a fabric test sample (more vertical travel identifies a more hydrophilic material). Two OPAN nonwoven layers may be used as adjacent layers in the fire protective material according to the invention, provided that a difference in wicking is observed between the two materials in the vertical wicking test. A large difference in hydrophilic properties between the two layers in the vertical wicking test is preferable. Thus, as used herein, hydrophobic is primarily a relative term, and a material is “hydrophobic” if the layer is more hydrophobic than the layer adjacent to it.

Native OPAN fibers are generally sufficiently hydrophilic to be used in the dual-layer structure of the invention. The fibers may be rendered more hydrophobic by providing them with a hydrophobic coating (sizing), such as a “stain-repellent” sizing, or the like. In embodiments the OPAN fibers used for the hydrophobic layer are coated with a polysiloxane. OPAN fibers with a suitable sizing may be provided as staple fibers for processing in a needlepunching apparatus. Examples of hydrophobic treatment for fibers is disclosed in U.S. Pat. No. 8,741,789 which is incorporated by reference.

Likewise, OPAN fibers may be made more hydrophilic by a suitable hydrophilic treatment, as disclosed in U.S. Pat. No. 4,073,993, which is also incorporated by reference.

Thus, “hydrophobic fibers” may refer to fibers that have been treated with a hydrophobic coating and “hydrophilic fibers” may refer to native fibers, or fibers that have been treated to make them hydrophilic, wherein both layers are predominantly OPAN fibers.

For the purposes herein, a “needlepunching apparatus” is a needlepunching loom, although other apparatuses capable of mechanically entangling fibers to form a felt may be used in certain embodiments. The extent of the needling or felting process may be determined by the degree of consolidation and by the number of penetrations per square inch (PPSI). The parameters of needlepunching and like apparatuses are known in the art, although they have not heretofore been adapted to make a layered felted OPAN product for fire protection and having wicking properties as disclosed herein. In examples, a target of 850 PPSI is used to attach and consolidate the layers. Care is taken when needlepunching an outer scrim to the substrate layers to ensure that a sufficient surface of the scrim is available to adhere to the aluminized film and not obstructed by OPAN fibers forced through the scrim in the process. Likewise, care is taken in a final needlepunching step to form breathable perforations in the aluminized film. In embodiments, perforations in the PET film may be made with a separate spiked roller apparatus which introduces an additional apparatus, but may allow more control of the process, potentially with less damage to the PET film.

The degree of consolidation controls the final weight of a felt and may be varied by changing the number of times that a fabric is put through the loom (passes). Preferably, the needlepunching apparatus is operated with sufficient passes to obtain a final garment material weight of 3-30 ounces per square yard. The industry looks for lower weight fabric that meets safety criteria. Thus, embodiments of the invention include a final garment material of 5-15 ounces per square yard. For the aluminized film, a single pass in the needlepunching loom may be sufficient to obtain perforations density in a range of 50-2000 PPSI, preferably 10-1000 PPSI, with perforations in the aluminum film currently being targeted around 250 PPSI to obtain a balance of fabric durability and fire-protection effectiveness as well as air and moisture transfer through the product.

Radiant heat resistant aluminized film is known in the art and may be, or may include, a laminate of aluminized polyethylene terephthalate (PET) which is then adhered to the two-layer nonwoven structure with a chemical adhesive and calendared with heat and pressure.

The dual layered OPAN felt may be constructed with a light supporting scrim, comprised of para-aramid, meta-aramid or a blend of para-aramid and meta-aramid, which may be needled onto the outer side of the hydrophilic and hydrophobic layers. The light scrim generally has a weight of 1-8 opsy, and in embodiments 1-2 opsy. In other embodiments, the scrim has a weight of 2-5 opsy. A scrim in the neighborhood of 3 ospy, made of a blend with para-aramid as the main component and meta-aramid as the minor component provides good abrasion resistance in combination with low weight and wearability. Needling the scrim into the outer layer is conducted so as to control the amount of fiber pushed through the scrim during the needling process. If too much staple fiber is available on the side of the scrim where the aluminized PET is applied, the adhesion of the PET film is weakened. The goal is to have the PET adhered primarily to the scrim and not on the loose staple fiber. Thus, at least half of the outer surface of the scrim may be free of the loose staple fibers. Fire-resistant adhesives may be used to adhere the PET film to the scrim, including for example, neoprene rubber with aluminum trihydrate as an additive. In some cases, a polysiloxane adhesive may be used for higher temperature applications.

The finished material is characterized by an air permeability of preferably 5-30 cubic feet per minute, which is determined by measuring air flow through the product according to ASTM D-737-96.

Additional characterization of the finished material is obtained with the ASTM E-96 test for moisture vapor transmission (MVT). A fire safety garment material according to the invention has improved MVT as compared to a garment material in which the aluminum is not perforated by needlepunching. The dual layer structure increases MVT compared to a material having a single hydrophobic layer. Embodiments of the invention exhibit MVT of greater than 500 g/m²/day

Materials according to the invention preferably meet or exceed molten metal protection standard ASTM F955-15. All of the aforesaid testing protocols are incorporated by reference.

Referring to the schematic FIG., radiant heat on the outside of the material is indicated by arrows 200, while the direction of moisture migrating away from the wearer's skin 100 is indicated by bold arrow 300. Moisture 202 is shown wicking into hydrophilic layer 20 from the skin 100 through tufts of hydrophilic fibers forming channels 12 in the hydrophobic layer 10. Perforations in aluminized layer 30 are schematically represented by the dotted pattern in the FIG. Lightweight scrim 40 supports the nonwoven layers 10, 20 and provides a surface for adhering the aluminized film.

### EXAMPLES

To manufacture and test exemplary safety garment materials according to the invention versus comparative examples, a first layer of hydrophilic fibers was added to a 1.5 opsy m-aramid scrim according to standard needlepunching felt manufacturing techniques. The target weight for these samples was 4 to 5 opsy. A second layer of hydrophobic fiber was attached to the first layer, likewise using standard needlepunching felt manufacturing techniques. The target weight for the hydrophobic material was 4 to 5 opsy. The combined felts were then re-needled with the hydrophilic fibers being pushed into and through the hydrophobic layer. PPSI (penetrations per square inch) range was targeted for these examples at 850 PPSI.

Following needlepunching of the OPAN layers, the aluminized PET was adhered and the fabric was calendared, the material was again needled through the aluminum side to perforate the film. PPSI (penetrations per square inch) was targeted at 250 PPSI.

In Examples 4-6 below, equal amounts of hydrophobic OPAN (polysiloxane coated) and hydrophilic OPAN were processed to create the dual layer base materials identified in Table 1, having finished weight in a range of 11.8-12.6 opsy.

Comparative Examples 1-3 were constructed using a single layer of hydrophobic OPAN to obtain samples with similar overall weight (12.3 to 13.3 opsy). As in Examples 4-6, the nonwoven layer construction was adhered to an aluminized PET film. However, in the Comparative Examples, the PET was not perforated. All of Examples 1-6 were supplied on a tee-shirt backing, which enabled a visual assessment of the burn through characteristics of the samples.

All of Examples 1-6 (examples with perforated PET film according to the invention as well as Comparative Examples) passed the molten metal resistance of ASTM F955-15, as depicted in the final column of Table 1 below. Thus, the perforations did not significantly impact the performance in the molten metal resistance test. Likewise, a slight increase in the temperature rise noted for the perforated samples of Examples 4, 5 and 6 remained well within the safety margin dictated by the Stohl curve. Shrinkage and delamination, which are determined visually according to a five-point scale, remained in the acceptable for the samples according to the invention.

TABLE 1

| | Weight | | | | | Max Temp | 2^{nd} Deg. | Pass/ |
|---|---|---|---|---|---|---|---|---|
| Example | (ospy) | Charring | Shrinkage | Adherence | Break | Rise (° C.) | Burn | Fail |
| Comp. Ex. No. 1 | 12.9 | 3 | 1 | 1 | 1 | 10.3 | No | Pass |
| Comp. Ex. No. 2 | 13.3 | 3 | 1 | 1 | 1 | 9 | No | Pass |
| Comp. Ex. No. 3 | 12.3 | 3 | 1 | 1 | 1 | 11.1 | No | Pass |
| Example 4 | 12 | 3 | 2 | 2 | 1 | 11.9 | No | Pass |
| Example 5 | 12.6 | 3 | 2 | 1 | 1 | 11.8 | No | Pass |
| Example 6 | 11.8 | 3.5 | 2 | 1 | 1 | 14.6 | No | Pass |

Moisture Vapor Transmission (MVT) was measured using ASTM E96 procedure B for representative samples of single layer base (as in Comparative Examples 1-3) and dual layer base materials (as in Examples 4-6). However, in all of the examples, a perforated PET film was used. A significant increase of MVT was noted for the material comprising a dual hydrophobic/hydrophilic construction as compared to a single hydrophobic base layer, as demonstrated in Table 2 below.

TABLE 2

| Construction | MVT (g/m²/day) |
|---|---|
| Double Layer Base: 50% Hydrophobic | 1615 |
| PAN Fiber/50% Hydrophilic PAN | |
| Fiber/Perforated Aluminized PET | |
| Double Layer Base: 50% Hydrophobic | 1524 |
| PAN Fiber/50% Hydrophilic PAN | |
| Fiber/Perforated Aluminized PET | |
| Single Layer Base: 100% Hydrophobic | 937 |
| PAN Fiber/Perforated Aluminized PET | |
| Single Layer Base: 100% Hydrophobic | 991 |
| PAN Fiber/Perforated Aluminized PET | |

All testing standards for characterizing the material are incorporated herein by reference. Reference to a Standard, such as an American Society for the Testing of Materials (ASTM) Standard, in this application and in subsequent applications claiming the benefit of priority, refers to the Standard in effect on the filing date of this application.

The description of the foregoing preferred embodiments is not to be considered as limiting the invention, which is defined according to the appended claims. The person of ordinary skill in the art, relying on the foregoing disclosure, may practice variants of the embodiments described without departing from the scope of the invention claimed. A feature or dependent claim limitation described in connection with one embodiment or independent claim may be adapted for use with another embodiment or independent claim, without departing from the scope of the invention.

What is claimed is:

1. A safety garment material, comprising:
an outer side and an inner, body-facing side;
a first nonwoven fabric hydrophobic layer on the inner, body-facing side consisting essentially of hydrophobic oxidized polyacrylonitrile fibers and having areal density of 2 to 8 ounces per square yard;
a second nonwoven fabric hydrophilic layer outward of the first nonwoven fabric layer, consisting essentially of hydrophilic oxidized polyacrylonitrile fibers, mechanically entangled with the first nonwoven fabric layer and having areal density of 2 to 8 ounces per square yard;
a perforated, radiant heat resistant outer layer comprising aluminum and having 50 to 2000 perforations per square inch.

2. The safety garment material according to claim 1, further comprising a scrim consisting essentially of para-aramid fibers, meta-aramid fibers or a combination thereof, having an areal density of 1 to 8 ounces per square yard on an outer side of said hydrophilic fabric layer, supporting the first and second nonwoven fabric layers.

3. The safety garment according to claim 2, wherein the radiant heat resistant outer layer is an aluminized polyethylene terephthalate (PET) film.

4. The safety garment material according to claim 3, wherein the perforations in the aluminized PET are created by needlepunching.

5. The safety garment material according to claim 2, wherein tufts of hydrophilic fibers reach the inner surface of the hydrophobic layer on the body facing side forming moisture-conducting channels in the hydrophobic layer.

6. The safety garment material according to claim 2, having a weight in a range of 3 to 30 ounces per square yard.

7. The safety garment material according to claim 2, exhibiting air permeability of 5 to 30 cubic feet per minute.

8. The safety garment material according to claim 2, exhibiting a water vapor transmission rate greater than 500 g/m²/day.

9. The safety garment material according to claim 2, wherein the hydrophobic OPAN fibers are provided with a water-repellent coating.

10. The safety garment material according to claim 9, wherein droplets of water applied to the hydrophobic fibers are not absorbed for at least ten-minutes and droplets of water applied to the hydrophilic fibers are absorbed within one minute.

11. The safety garment material according to claim 2, stitched or bonded to form sleeves or leggings of personal protective equipment.

12. A method for making safety garment material, comprising:
laying up 2 to 8 ounces per square yard of hydrophilic staple oxidized polyacrylonitrile (OPAN) fibers and 2 to 8 ounces per square yard of hydrophobic staple oxidized OPAN fibers in a needlepunching apparatus with a supporting outer scrim consisting essentially of para-aramid fibers, meta-aramid fibers, or a combination thereof having a weight of 2-5 ounces;
performing a needlepunching operation to consolidate the layers, forming a consolidated fabric having a body-facing layer of predominantly hydrophobic fibers, a layer outward of the hydrophobic layer of predominantly hydrophilic fibers, and an outer scrim; wherein
tufts of the hydrophilic fibers reach the body-facing side of the predominantly hydrophobic layer, forming moisture-conducting channels through the hydrophobic body-facing layer;
adhering an aluminized film to the outer scrim; and
performing a needlepunching operation to form perforations in the aluminized film to form a wicking, layered fire-protecting garment material.

13. The method according to claim 12, comprising
laying up the about the same amount of hydrophilic staple OPAN fibers and hydrophobic OPAN fibers.

14. The method according to claim 12, comprising performing said needlepunching operation to form perforations in the aluminized film having a perforation density of of 10-1000 penetrations per square inch.

15. The method according to claim 12, comprising providing the hydrophobic fibers with a polysiloxane coating to render them hydrophobic.

16. The method according to claim 12, wherein the finished material has an areal density in a range of 3 to 30 ounces per square yard.

17. The method according to claim 12, wherein the finished material exhibits water vapor transmission rate of greater than 500 g/m²/day.

18. The method according to claim 12, wherein the finished material exhibits air permeability of 5 to 30 cubic feet per minute.

19. The method for making safety garment material according to claim 12, further comprising stitching and/or bonding the material to form personal protective equipment having sleeves and/or leg-holes.
